(19) United States
(12) Patent Application Publication
(10) Pub. No.: US 2024/0247809 A1
(43) Pub. Date: Jul. 25, 2024

(54) ZONAL ELECTRIC GRILL

(71) Applicant: W.C. BRADLEY CO., Columbus, GA (US)

(72) Inventors: JAMES D. KRING, Opelika, AL (US); RAMIN KHOSRAVI RAHMANI, Columbus, GA (US); Seth Sawyer, Columbus, GA (US); Thomas Kessler, Columbus, GA (US)

(21) Appl. No.: 18/420,442

(22) Filed: Jan. 23, 2024

Related U.S. Application Data
(60) Provisional application No. 63/440,573, filed on Jan. 23, 2023.

(51) Int. Cl. F24C 7/08; A23L 5/10; A47J 36/32; A47J 37/07; G05D 23/19

(52) U.S. Cl. CPC F24C 7/082; A23L 5/15; A47J 36/32; A47J 37/0709; G05D 23/1934

(57) ABSTRACT

An electric grill includes a firebox divided into a plurality of zones. Each zones has an electric heating element, and a temperature probe. A controller having operative control to detect temperatures using the temperature probes adjusts power to the electric heating element for each of the plurality of zones.

### CROSS-REFERENCE TO RELATED CASES

This application claims the benefit of U.S. provisional patent application Ser. No. 63/440,573, filed on Jan. 23, 2023, and incorporates such provisional application by reference into this disclosure as if fully set out at this point.

### FIELD OF THE INVENTION

This disclosure relates to electric cooking devices in general and, more particularly, to an electric grill with separately controllable cooking zones.

### BACKGROUND OF THE INVENTION

The traditional electric grills lack the ability to achieve a desired temperature with accuracy, and they cannot maintain the temperature steadily. Even if such a system can get close to the desired temperature initially, it is not thermostatically controlled and cannot adjust to any changes in ambient conditions without continuous involvement of the user and his/her guesswork.

On the other hand, some single-point-controlled electric grills can provide a reasonable performance when the cooking chamber is relatively small, the expected operation range is limited, and the entire cooking space is sought to have the same temperature. The control system of such a grill treats the entire cooking volume as a single zone, but does not provide ability for the user to fine-tune the temperature or to create and control different temperature zones inside the same cooking volume. This also rules out the possibility of indirect cooking. Even as a single-zone cooking device, a single-point-controlled system cannot precisely provide a uniform temperature across the cooking surface as it relies on a single point reading to assign a temperature value across the entire cooking surface. The limitations of such an approach become even more pronounced in units with larger volumes and wider range of operations. As the volume of the cooking chamber increases, the natural temperature gradient inside that chamber increases and the single-point-controlled system becomes more erroneous.

What is needed is a system and method to address the above, and related, issues.

### SUMMARY OF THE INVENTION

The invention of the present disclosure, in one aspect thereof, comprises an electric grill having a firebox divided into a plurality of zones. Each zone includes an electric heating element, and a temperature probe. A controller having operative control to detect temperatures using the temperature probe adjusts power to the electric heating element for each of the plurality of zones.

In some embodiments, the controller operates each of the plurality of zones in a synchronized cycle wherein each of the plurality of zones is maintained at the same temperature. The controller may operates each of the plurality of zones in a desynchronized cycle wherein each of the plurality of zones is assigned maintained at its own temperature. The controller may also operate the plurality of zones in an indirect cycle wherein at least one of the plurality of zones is operated to utilize its electric heating element to maintain a temperature in another one of the plurality of zones.

The grill may include a divider between at least two of the plurality of zones. The divider may be insulated. The grill may include an additional temperature probe in the firebox separate from the zone temperature probes and communicatively coupled to the controller.

The invention of the present disclosure in another aspect thereof, comprises an electric grill including a firebox having at least first and second heating zones containing first and second heating elements, respectively. The grill includes first and second cooking surfaces above the first and second heating elements, respectively. The grill includes first and second temperature probes, in the first and second heating zones, respectively. An electric power supply is included. A controller has operative control to adjust electric power from the electrical power supply to the first and second heating elements. First and second temperature probes are situate to measure a temperature associated with the first and second heating zones, respectively, each being communicatively coupled to the controller to provide temperature information thereto. The controller executes a plurality of programs to control the first and second heating elements.

In some embodiments, one of the plurality of programs comprises a synchronized cycle wherein the first and second heating zones are maintained at the same temperature. One of the plurality of programs may comprise a desynchronized cycle wherein the first heating zone is maintained at a first temperature, and the second heating zone is maintained at a second temperature and the first and second temperatures may or may not be equivalent. One of the plurality of programs may utilize the first heating element to maintain a predetermined temperature in the second heating zone.

Some embodiments have an insulated divider interposes the first and second heating elements. At least one user control may be physically present on the grill, and may communicatively coupled to the controller to input which of the plurality of programs the controller executes. In some embodiments, the at least one user control communicates to the controller a target temperature for at least one of the first and second heating zones.

The first and second temperature probes may be calibrated to measure air temperature. The first and second temperature probes may be calibrated to measure surface temperature of the first and second cooking surfaces, respectively.

The invention of the present disclosure, in another aspect thereof, comprises a method of operating an electric grill. The method includes providing a firebox with at least first and second heating zones each containing first and second heating elements, respectively. The method includes providing a controller having operative control to power, and adjust power, to the first and second heating elements from a power supply. The method includes providing first and second temperature probes in the first and second heating zones, respectively, each being communicatively coupled to the controller. The controller is used to maintain a predetermined first and second temperature in each zone.

### BRIEF DESCRIPTION OF THE DRAWINGS

FIG. 1 is a perspective view of a zonal electric grill according to aspects of the present disclosure.

FIG. 2 is a perspective view of the zonal electric grill of FIG. 1 with cooking grates removed.

FIG. 3 is an overhead view of the zonal electric grill as shown in FIG. 2.

FIG. 4 is a perspective view of a zonal electric grill according to aspects of the present disclosure with an additional temperature probe.

FIG. 5 is a general control flow chart according to aspects of the present disclosure.

FIG. 6 is a flowchart of a synchronized cooking cycle according to aspects of the present disclosure.

FIG. 7 is a flowchart of a desynchronized cooking cycle according to aspects of the present disclosure.

FIG. 8 is a flowchart of an indirect cooking cycle according to aspects of the present disclosure.

FIG. 9 is a simplified schematic diagram of a control system for a zonal electric grill according to the present disclosure.

### DETAILED DESCRIPTION OF THE PREFERRED EMBODIMENTS

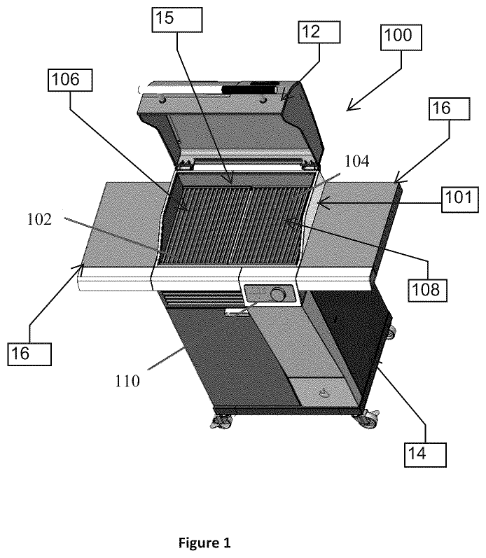

Referring now to FIG. 1, a perspective view of a dual-zone digitally controlled electric grill 100 is shown. The grill 100 may include a firebox 101 with an openable lid 12 to cover a cooking surface 15. The cooking surface 15 may comprise one or more cooking grates. As illustrated, the cooking surface 15 comprises two separate cooking grates 106, 108. In some the cooking surface 15 comprises one or more griddles or other cooking surfaces or implements. The firebox 101 may be supported on a cart 14 or other implement. The firebox 101 may also be permanently installed in a permanent outdoor location or elsewhere. Some embodiments provide side shelves 16 attached to the cart 14 or firebox 101, as well as other accessories as known in the art.

In some embodiments, the firebox 101 is divided into two zones labeled as Zone 1 (102) and Zone 2 (104). In FIG. 1, cooking gates 106, 108 can be seen in or covering Zones 1 (102) and Zone 2 (104), respectively. It should be understood that a firebox, cooking surface, or grate could be separated or divided into more than two zones in other embodiments. For example, some embodiments could utilize three or four zones.

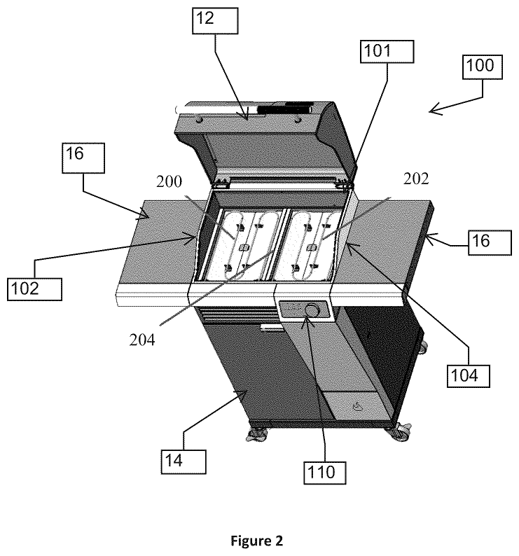

Referring now to FIG. 2 another perspective view of the dual-zone digitally controlled electrical grill 100 is shown with grates 106, 108 removed to illustrate internal components of the firebox 101. Each zone 102, 104 has a separately-controlled heating element 200, 202, respectively, in the firebox 101. According to the present disclosure, heating elements may comprise resistive heating elements as known in the art. The heating elements 102, 202 may be separated by a boundary or divider 204, which may also serve to divide or demarcate the zones 102, 104. This divider 204 may be insulated for temperature regulation of the zones 200, 104.

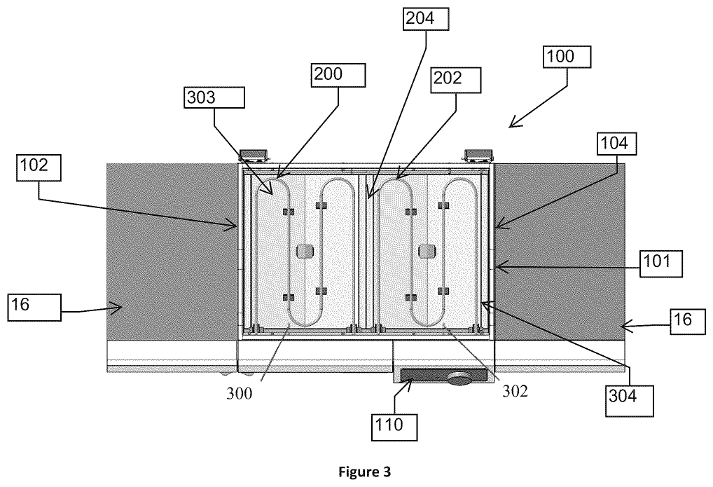

Referring now to FIG. 3, an overhead view of the zonal electric grill 100 is shown. Each zone 102, 104 may be controlled based on information or data provided by a temperature probe 300, 302 dedicated to the respective zone 102, 104. Locations of temperature probes 300, 302 are exemplary only as shown. In some embodiments, more than one temperature probe may be utilized per zone to increase the available data. If additional zones are provided, each may have one or more temperature probes.

In the illustrated embodiment, each zone 102, 104 has an independent element box, 303, 304, respectively, allowing the zones 102, 204. The divider 204 may be considered part of the element boxes 303, 304. The element boxes 303, 304 may comprise thermally reflective materials and/or insulation. Element boxes 303, 304 allow the heating elements 200, 202 and the respective zones 102, 104 to be thermally separated and insulated from each other.

Each zone (e.g., 102, 104) may be powered or heated by a single heating element dedicated to a given zone. Alternatively, each zone can be powered by more than one heating element. For instance, each zone may have one heating element providing sufficient heat for low-temperature cooking and one or more additional heating elements to provide for high-heat cooking. In another example, each zone has one heating element providing sufficient heat for a wide range of cooking under most ambient conditions, with one or more zones provided with one or more additional heating elements to provide “boosting.” Such boosting may be utilized when shorter heat-up times (and shorter recovery time) are desired, or when extreme cold ambient requires a boost to the provided heat to the cooking zone, for example.

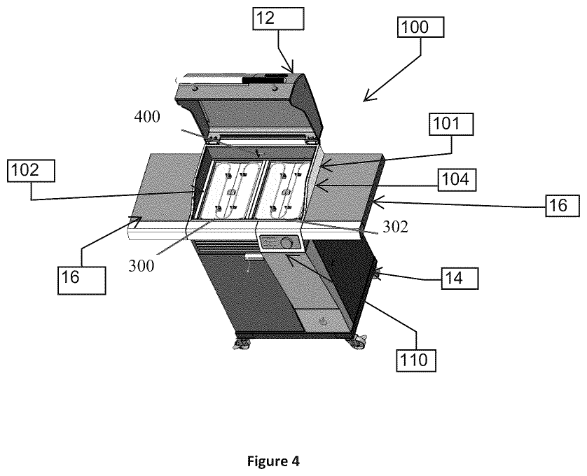

Feedback in the form of temperature readings may be provided the temperature probes 300, 302 assigned to each zone 102, 104. Referring now to FIG. 4 a perspective view of the zonal electric grill 100 with an additional temperature probe 400 is shown. Probe 400 may be placed inside the cooking chamber 101 to provide the air temperature of the cooking chamber cavity, when desired (for example for indirect cooking or for the low and slow smoking process). Temperature probes utilized with embodiments of the present disclosure may be resistivity based, or based upon other technology or methods known to the art.

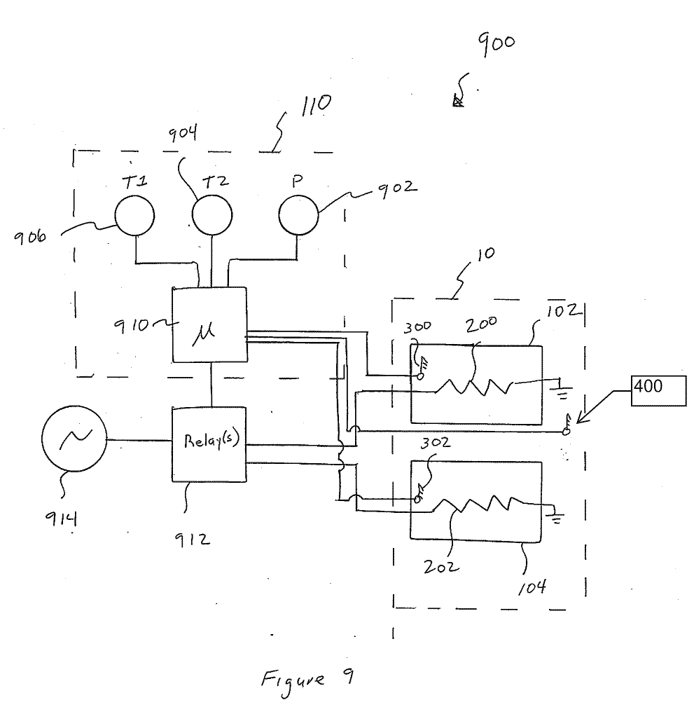

Referring now to FIG. 9 is a simplified schematic diagram 900 of a control system 110 for a zonal electric grill according to the present disclosure is shown. The control system 110 may comprise an electronic microcontroller 910, which may comprise a programmable silicon device capable of executing the control methods described herein. The microcontroller 910 may comprise a system-on-a-chip device, as is known in the art, and may include on board memory, I/O ports, etc. The microcontroller 910 may also comprise a field programmable gate array (FPGA) and application specific integrated circuit (ASIC) or another device capable of implementing the control methodology as may be known in the art.

The microcontroller is 910 communicatively coupled to temperature probes 300, 302, 400.

In the present embodiment, a knob 902, communicatively coupled to the microcontroller, allows for powering on and/or selection of the program to be followed (the programming and control methods being described further below). A knob 906 may be provided for selection of a desired temperature for Zone 1, and a knob 904 may be provided for selection of a desired temperature for Zone 2 (e.g., when the zone are not synchronized. One of skill in the art will appreciate that functions may be combined onto fewer knobs in some cases. Switches or sliders can also provide control inputs. Touch screens and remote control (e.g., via an app) are also provided in other embodiments. Wireless communications or commands may be received over the air (e.g., from the internet, a cloud server, a remote computer, or a mobile device). In some cases the microcontroller 910 provides such functionality natively. In other embodiments, separate communications chips or other devices may be employed.

Necessary relays, amplifiers, switch gear and other circuit components may be provided as needed to enable to control system 110 to operate as described herein, and particularly to allow the microcontroller 910 to have operative control over the heating elements. In the present embodiment, such devices are shown as a relay bank 912. A power supply 914 for the system 900 may comprise household AC main power. In some embodiments, the power supply 914 may comprise a direct current source, such as a battery. AC to DC or DC to AC conversion may be provided as function of the relay bank 912 or in a separate device or component as known in the art.

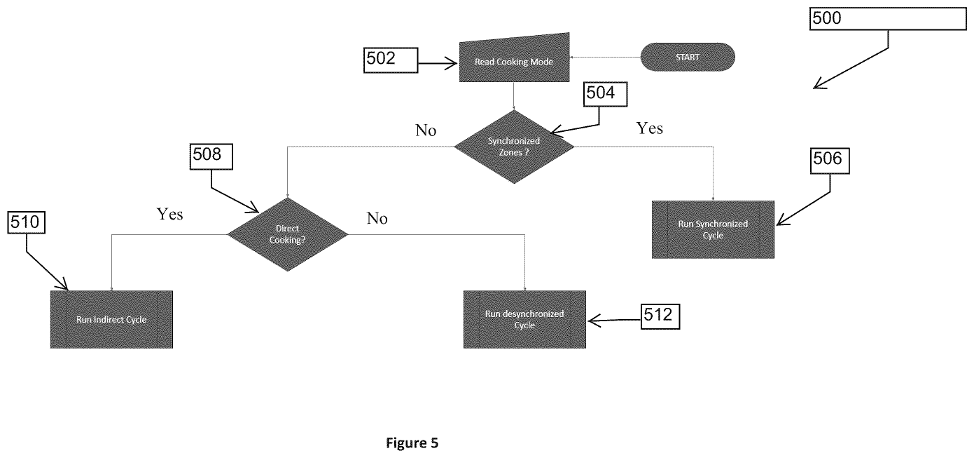

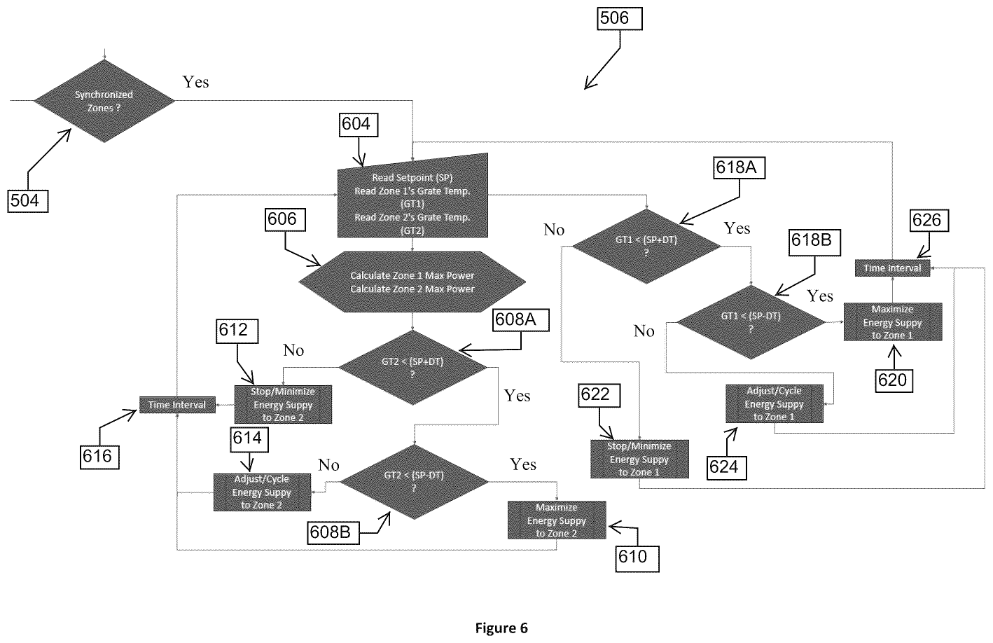

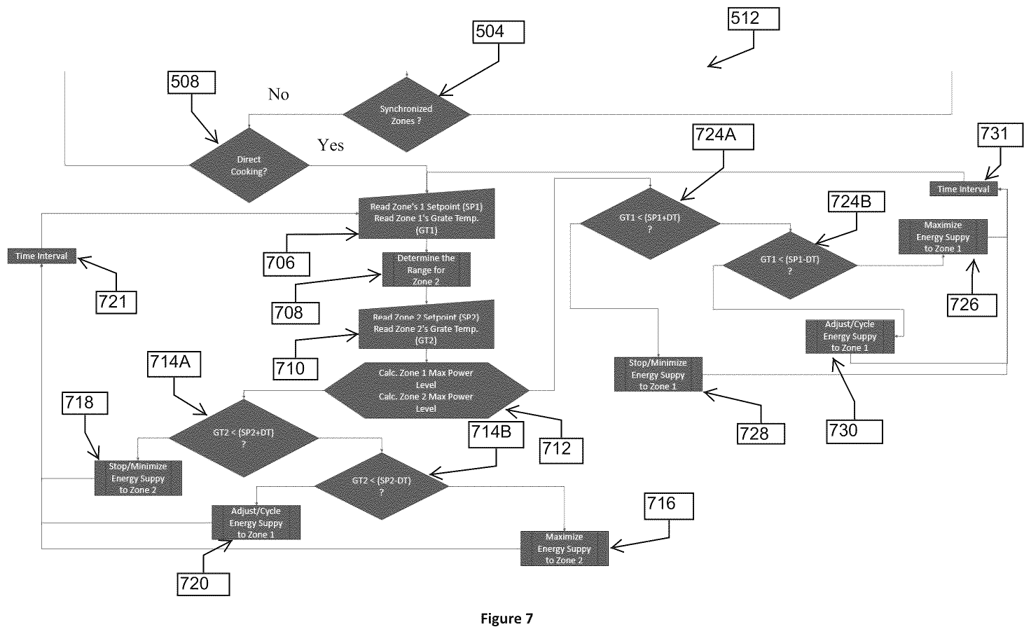

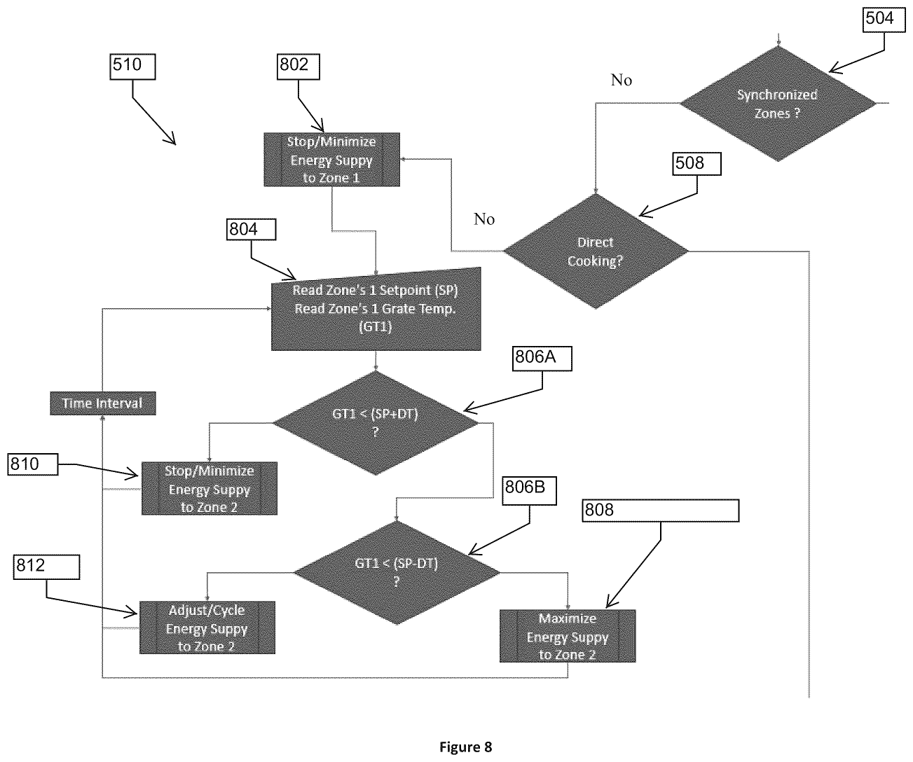

Exemplary logic or methodology implemented by the control systems according to the present disclosure (e.g., control system 110) is illustrated in FIGS. 5-8. According to one control method, there are three main control cycles (each one with its own sub-cycles): a synchronized cycle, a desynchronized cycle, and an indirect cycle. FIG. 5 is a general control flow chart according to aspects of the present disclosure wherein the various cycles are selected and started. FIG. 6 is a flowchart of the synchronized cooking cycle; FIG. 7 is a flowchart of the desynchronized cooking cycle; and FIG. 8 is a flowchart of the indirect cooking cycle.

As shown in FIG. 5, a general control cycle 500 may begin by reading the selected cooking mode at step 502. Determination may then be made at steps 504 and 508 whether the synchronized cycle 506, the desynchronized cycle 512 or the indirect cycle 510 is selected.

Beginning with FIG. 5, the synchronized 506 cycle assigns the same setpoint to the entire grill 100. Using the data provided by temperature probes 300, 302 in each zone 102, 104, the system controls the heating elements 200, 202 to provide precise uniform temperature across the entire cooking surface. Depending on the setpoint and desired type of cooking, the target temperature could be the cooking grate temperature (more suitable for applications such as grilling) or the cooking chamber air temperature (more suitable for applications such as slow cooking). Raw readings (possibly in the form of a voltage) from a temperature probe are calibrated appropriately for the chosen cooking method and setpoint as known in the art. Calibration may be based on temperature at a predetermined location (e.g., the cooking surface, or air temperature inside the firebox) correlated to the raw data received from a probe at such temperature.

The desynchronized cycle 512 may be used when different cooking methods and/or temperatures are desired. This allows for zonal cooking as each cooking zone 102, 104 will be controlled exclusively with respect to its chosen setpoint.

The indirect cycle 510 may allow for cooking on one zone while the heat is provided indirectly from another zone. The control system 110 uses the temperature probe dedicated to the cooking zone to control the heating element in the neighboring zone(s) to provide precise indirect cooking. Again, depending on the setpoint for the indirect cooking, the target temperature could be the cooking grate temperature or the cooking chamber air temperature.

Referring particularly now to FIG. 6, the synchronized cooking cycle 506 is more fully illustrated. When it is determined at step 504, for example, that the synchronized cycle should run, all zones target the same setpoint (SP). For each given zone, the control system 110 checks the difference between the readings of the temperature for that zone (GT) and the target (SP) at step 604. The control system 110 calculates the maximum power level required for each zone based on SP and GT for that zone at step 606. This allows for smart power sharing management to optimize the power usage and maximize the system efficiency which becomes more important when the supply power is limited. It should also be noted that systems and methods of the present disclosure also allow for greater than half of the available power to be expended on a given zone (this presumes two zones, if there are ‘n’ zones in a system, then greater than 1/n of the available power can be expended in single zone). Stated another way, for each zone, depending upon current setpoints and grill temperatures, power allocated to a given zone can vary between zero and all of the power available to the system. This may be important, for example, if one zone has a larger food item and thus a larger heat sink to contend with.

As shown at steps 608A and 608B for Zone 2, if the temperature of the given zone is lower than the setpoint by more than a predetermined threshold (DT), then the control system 110 energizes that zone with the maximum power rate (determined for that zone) at step 610. If the temperature of the given zone is higher than the setpoint by more than a predetermined threshold, then the control system 110 minimizes the power delivered to that zone at step 612. If the temperature is in between (i.e., ABS(GT−SP)≤DT), then the control system 110 dynamically adjusts the rate of the power supply to that zone at step 614 (e.g., by varying the applied voltage).

Similar to the above, for Zone 1, as shown at steps 618A and 618B if the temperature of the given zone is lower than the setpoint by more than a predetermined threshold (DT), then the control system 110 energizes that zone with the maximum power rate (determined for that zone) at step 620. If the temperature of the given zone is higher than the setpoint by more than a predetermined threshold, then the control system 110 minimizes the power delivered to that zone at step 622. If the temperature is in between (i.e., ABS(GT−SP)≤DT), then the control system 110 dynamically adjusts the rate of the power supply to that zone at step 624 (e.g., by varying the applied voltage).

The predetermined threshold can be a function of the setpoint. It also can depend on whether the temperature value is above the setpoint or below the setpoint. Depending on the setpoint, the raw data provided by the temperature probes can be processed differently (using different calibrations) to determine either the grate temperature or the air temperature (whichever is more suitable for the sought method of cooking). Although all the zones are targeting the same setpoint, each zone is controlled individually.

It should be understood that the control branches for Zone 1 and Zone 2 may occur simultaneously, or as part of a threaded process such that the control for each occurs in real time. Following each control loop for Zone 2, a time interval may be allowed to pass at step 616 before repeating the control loop. Similarly, a time interval delay at step 626 may occur for Zone 1.

FIG. 7 illustrates the desynchronized cooking cycle 700. This would occur if the synchronized cycle is not selected at step 504 but direct cooking is selected at step 508. All zones are involved in direct cooking, however, targeting different setpoints (SP). For each zone, the control system 110 checks the difference between the readings of the temperature for that zone (GT) and the target (SP). In the diagram 512, reading Zone 1 SP and GT is at step 706. Zone 2 SP and GT are read at step 710. At step 708, the range available for Zone 2 may be determined (assuming the first temperature set is for Zone 1). This may be based in part on the temperature selected for Zone 1, as a very high temperature setting for Zone 1 can limit the range available to Zone 2 based on power availability.

The system calculates the maximum power level required for each zone based on SP and GT for that zone at step 712. If the temperature of Zone 2 is lower than the setpoint by more than a predetermined threshold (DT) as determined at steps 714A,B, then the control system 110 energizes Zone 2 with the maximum power rate at step 716. If the temperature of the Zone 2 is higher than the setpoint by more than a predetermined threshold, then the control system 110 minimizes the power delivered to Zone 2 at step 718. If the temperature is in between, ABS(GT−SP)≤DT, then the control system 110 dynamically adjusts the rate of the power supply to Zone 2 at step 720 (e.g., by varying the applied voltage).

The process for Zone 1 mirrors that of Zone 2. If the temperature of Zone 1 is lower than the setpoint by more than a predetermined threshold (DT) as determined at steps 724A,B, then the control system 110 energizes Zone 1 with the maximum power rate at step 726. If the temperature of the Zone 1 is higher than the setpoint by more than a predetermined threshold, then the control system 110 minimizes the power delivered to Zone 1 at step 728. If the temperature is in between, ABS(GT−SP)≤DT, then the control system 110 dynamically adjusts the rate of the power supply to Zone 1 at step 730 (e.g., by varying the applied voltage).

The predetermined threshold may be a function of the setpoint. The first chosen setpoint can impact the available range for the other zone(s). This is to prevent the situation that a user tries to choose a series of setpoints that cannot be achieved simultaneously. Depending on the setpoint, the raw data provided by the temperature probes may be processed differently (using different calibrations) to determine either the grate temperature or the air temperature.

It can also be seen that appropriate delays or time intervals may be built into the process (e.g., at steps 721, 731) to allow heating elements time to heat up or cool down rather than continually adjusting power before heating elements have had time to react. It should also be understood that the control processes for Zones 1 and 2 may occur sequentially or simultaneously. It should be pointed out here again that systems and methods of the present disclosure can provide from zero power up to maximum available power to a given zone if demands require it and the power is not currently needed for another zone. For example, in the desynchronized operation mode, one zone may reach its setpoint much sooner, or be able to maintain its setpoint with much less power, than another zone. The system may thus divert more power when needed to the zone with higher demands for power.

FIG. 8 illustrates the indirect cooking cycle 510. This cycle may occur when neither synchronized cooking is selected at step 504 nor direct cooking at step 508. One zone is where the food is placed (main zone), and other zone(s) would provide the indirect heat for cooking. In this example, Zone 1 is to be used for cooking but Zone 2 or another zone in the case or three or more zones could be used for cooking. After stopping the energy supply at step 802, for the zone with the food (here, Zone 1), the control system 110 checks the difference between the readings of the temperature for that zone (GT) and the target (SP) at step 804. As determined at steps 806A and 806B, if the temperature of the given zone is lower than the setpoint by more than a predetermined threshold (DT), then the control system 110 energizes the neighbor zone(s) with the maximum power rate at step 808. If the temperature is higher than the setpoint by more than a predetermined threshold, then the control system 110 minimizes the power rate at step 810. If the temperature is in between, then the control system 110 dynamically adjusts the rate of the power supply to the neighbor zones at step 812. The predetermined threshold can be a function of the setpoint. Depending on the setpoint, the raw data provided by the temperature probe can be processed differently (using different calibrations) to determine either the grate temperature of or the air temperature.

Although the illustrations are focused to a dual-zone grill, the application of this innovation can be applied by one of skill in the art to multi-zone electric grills with an even larger number of zones following the same principles provided herein.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An electric grill comprising:
a firebox divided into a plurality of zones wherein each zone includes:
an electric heating element; and
a temperature probe;
a controller having operative control to detect temperatures using the temperature probe and adjust power to the electric heating element for each of the plurality of zones.

2. The electric grill of claim 2, wherein the controller operates each of the plurality of zones in a synchronized cycle wherein each of the plurality of zones is maintained at the same temperature.

3. The electric grill of claim 2, wherein the controller operates each of the plurality of zones in a desynchronized cycle wherein each of the plurality of zones is assigned maintained at its own temperature.

4. The electric grill of claim 2, wherein the controller operates the plurality of zones in an indirect cycle wherein at least one of the plurality of zones is operated to utilize its electric heating element to maintain a temperature in another one of the plurality of zones.

5. The electric grill of claim 2, further comprising a divider between at least two of the plurality of zones.

6. The electric grill of claim 5, wherein the divider is insulated.

7. The electric grill of claim 2, further comprising an additional temperature probe in the firebox separate from the zone temperature probes and communicatively coupled to the controller.

8. An electric grill comprising:
a firebox having at least first and second heating zones containing first and second heating elements, respectively;
first and second cooking surfaces above the first and second heating elements, respectively;
first and second temperature probes, in the first and second heating zones, respectively;
an electric power supply;
a controller having operative control to adjust electric power from the electrical power supply to the first and second heating elements; and
first and second temperature probes situated to measure a temperature associated with the first and second heating zones, respectively, each being communicatively coupled to the controller to provide temperature information thereto;
wherein the controller executes a plurality of programs to control the first and second heating elements.

9. The electric grill of claim 8, wherein one of the plurality of programs comprises a synchronized cycle wherein the first and second heating zones are maintained at the same temperature.

10. The electric grill of claim 8, wherein one of the plurality of programs comprises a desynchronized cycle wherein the first heating zone is maintained at a first temperature, and the second heating zone is maintained at a second temperature and the first and second temperatures may or may not be equivalent.

11. The electric grill of claim 8, wherein one of the plurality of programs utilizes the first heating element to maintain a predetermined temperature in the second heating zone.

12. The electric grill of claim 8, wherein an insulated divider interposes the first and second heating elements.

13. The electric grill of claim 8, further comprising at least one user control on the grill that is communicatively coupled to the controller to input which of the plurality of programs the controller executes.

14. The electric grill of claim 11, wherein the at least one user control communicates to the controller a target temperature for at least one of the first and second heating zones.

15. The electric grill of claim 8, wherein the first and second temperature probes are calibrated to measure air temperature.

16. The electric grill of claim 8, wherein the first and second temperature probes are calibrated to measure surface temperature of the first and second cooking surfaces, respectively.

17. A method of operating an electric grill comprising:
providing a firebox with at least first and second heating zones each containing first and second heating elements, respectively;
providing a controller having operative control to power, and adjust power, to the first and second heating elements from a power supply;
providing first and second temperature probes in the first and second heating zones, respectively, each being communicatively coupled to the controller; and
using the controller maintain a predetermined first and second temperature in each zone.
